(19) United States
(12) Patent Application Publication
(10) Pub. No.: US 2025/0259345 A1
(43) Pub. Date: Aug. 14, 2025

(54) IMAGE PROCESSING METHOD AND APPARATUS, DEVICE, AND MEDIUM

(71) Applicant: Beijing Zitiao Network Technology Co., Ltd., Haidian District, Beijing (CN)

(72) Inventors: Fei DING, Beijing (CN); Wei LIU, Beijing (CN)

(21) Appl. No.: 18/860,337

(22) PCT Filed: Apr. 21, 2023
(86) PCT No.: PCT/CN2023/089724

§ 371 Date: Oct. 25, 2024

(30) Foreign Application Priority Data
Apr. 25, 2022 (CN) 202210443514.9

(51) Int. Cl. G06T 11/00; G06T 7/11; G06T 7/90; G06T 11/60; G06V 10/56

(52) U.S. Cl. CPC G06T 11/001; G06T 7/11; G06T 7/90; G06T 11/60; G06V 10/56; G06T 2207/10024

(57) ABSTRACT

An image filling method for reducing filling process in producing animation. The image filling method includes the steps of extracting color information of each pixel of a line drawing to be filled, wherein said line drawing to be filled includes a coloured line which is a boundary line dividing said line drawing to be filled into regions, a color of the boundary line specifying a color used for filling the boundary line; extracting boundary line information representing whether said each pixel is on the boundary line or not by using said color information; filling said line drawing except the boundary line by using said boundary line information; and filling said colored line by using said boundary line information.

### CROSS-REFERENCE TO RELATED APPLICATIONS

The present application is based on and claims priority to Chinese Patent Application No. 202210443514.9 filed on Apr. 25, 2022, the disclosure of which is incorporated by reference herein in its entirety.

### TECHNICAL FIELD

The present disclosure relates to a technical field of a computer application, and in particular, to an image processing method and an apparatus, a device, and a medium.

### BACKGROUND

Coloring a line drawing image is common image processing means, for example, upon creating two-dimensional characters in games, coloring the two-dimensional characters, etc., belongs to a common requirement in creating game characters.

### SUMMARY

In order to solve the above technical problem or at least partially solve the above technical problem, the present disclosure provides an image processing method and an apparatus, a device, and a medium.

An embodiment of the present disclosure provides an image processing method comprising: acquiring a line drawing and initial color prompt information from a user; coloring the line drawing based on the initial color prompt information to generate an initial colored image for the line drawing; acquiring color modification information associated with the initial colored image from the user; generating target color prompt information based on the initial color prompt information, the color modification information and the initial colored image; and coloring the line drawing based on the target color prompt information to generate a target colored image for the line drawing.

An embodiment of the present disclosure further provides an image processing apparatus comprising: a first acquisition module configured to acquire a line drawing and initial color prompt information from a user; a first generation module configured to generate an initial colored image for the line drawing by coloring the line drawing based on the initial color prompt information; a second acquisition module configured to acquire color modification information associated with the initial colored image from the user; a second generation module configured to generate target color prompt information based on the initial color prompt information, the color modification information and the initial colored image; and a third generation module configured to generate a target colored image for the line drawing by coloring the line drawing based on the target color prompt information.

An embodiment of the present disclosure further provides an electronic device comprising: a processor; a memory configured to store instructions executable by the processor, the executable instructions are executed by the processor for implementing the image processing method according to the embodiment of the present disclosure.

An embodiment of the present disclosure further provides a computer readable storage medium storing a computer program executed by a processor for implementing the image processing method according to the embodiment of the present disclosure.

An embodiment of the present disclosure further provides a computer program product comprising a computer program/instruction executed by a processor for implementing the image processing method according to the embodiment of the present disclosure.

An embodiment of the present disclosure further provides a computer program comprising program codes executed by a processor for implementing the image processing method according to the embodiment of the present disclosure.

### BRIEF DESCRIPTION OF THE DRAWINGS

The above and other features, advantages, and aspects of various embodiments of the present disclosure will become more apparent with reference to the following detailed description taken in conjunction with the accompanying drawings. Throughout the drawings, the same or similar reference numbers refer to the same or similar elements. It should be understood that the drawings are schematic and that originals and elements are not necessarily drawn to scale.

FIG. 1 is a schematic flow diagram of an image processing method in an embodiment of the present disclosure;

FIG. 2 is a schematic diagram of an image processing scenario in an embodiment of the present disclosure;

FIG. 3 is a schematic diagram of another image processing scenario in an embodiment of the present disclosure;

FIG. 4 is a schematic diagram of another image processing scenario in an embodiment of the present disclosure;

FIG. 5 is a schematic diagram of another image processing scenario in an embodiment of the present disclosure;

FIG. 6 is a schematic flow diagram of another image processing method in an embodiment of the present disclosure;

FIG. 7 is a schematic diagram of another image processing scenario in an embodiment of the present disclosure;

FIG. 8 is a schematic diagram of another image processing scenario in an embodiment of the present disclosure;

FIG. 9 is a schematic diagram of another image processing scenario in an embodiment of the present disclosure;

FIG. 10 is a schematic flow diagram of another image processing method in an embodiment of the present disclosure;

FIG. 11 is a schematic flow diagram of another image processing method in an embodiment of the present disclosure;

FIG. 12 is a schematic structural diagram of an image processing apparatus in an embodiment of the present disclosure;

FIG. 13 is a schematic structural diagram of an electronic device in an embodiment of the present disclosure.

### DETAILED DESCRIPTION

Embodiments of the present disclosure will be described in further detail below with reference to the accompanying drawings. While certain embodiments of the present disclosure are shown in the accompanying drawings, it should be understood, however, that the present disclosure may be realized in various forms and should not be construed as being limited to the embodiments set forth herein, and these embodiments are provided for a more thorough and complete understanding of the present disclosure. It should be understood that the accompanying drawings and embodiments of the present disclosure are for exemplary purposes only and are not used to limit the scope of protection of the present disclosure.

It should be understood that individual steps recited in the method implementation of the present disclosure may be performed in a different order, and/or performed concurrently. Furthermore, the method implementation may include additional steps and/or omit performing the illustrated steps. The scope of the present disclosure is not limited in this aspect.

The term “including” and its variations as used herein mean an open-ended inclusion, i.e., “including but not limited to”. The term “based on” means “at least in part based on”. The term “an embodiment” represents “at least one embodiment”, the term “another embodiment” represents “at least one additional embodiment”, and the term “some embodiments” represents “at least some embodiments”. Definitions related to other terms will be given in the following description.

It should be noted that concepts such as “first” and “second” mentioned in the present disclosure are only used to distinguish between different apparatus, modules or units, and are not used to define the sequence or interdependence of the functions performed by these apparatus, modules or units.

It should be noted that the modifications of “one” and “a plurality of” mentioned in the present disclosure are schematic and not limiting, and those skilled in the art should understood that they should be construed as “one or more”, unless the context clearly indicates otherwise.

The names of the messages or information interchanged between the plurality of apparatus in the implementations for the present disclose are used for illustrative purposes only and are not used to limit the scope of those messages or information.

In the technology related to coloring the line drawing image, after obtaining the line drawing image, a technician in related art performs coloring processing by adopting the coloring function of a relevant application, based on personal experience and a requirement document for coloring. If the user is not satisfied with the coloring result, it is necessary to erase the corresponding color and re-color the drawing. However, the above-described process for coloring the line drawing relies on manual coloring by the user, and relies on manual modifications by the user when the coloring result for the line drawing is unsatisfactory, resulting in a low efficiency of the coloring.

In order to solve the above problem, an embodiment of the present disclosure provides an image processing method, in which the user only needs to provide simple color prompt information to generate an exquisite line drawing coloring result, and meanwhile, refined color modifications can be made to the colored image, which not only provides intelligent coloring processing, but also supports refined color modifications, meets the user's personalized requirements for coloring, and realizes an improvement in the coloring efficiency on the basis of ensuring the coloring effect.

The method is introduced below in conjunction with specific embodiments.

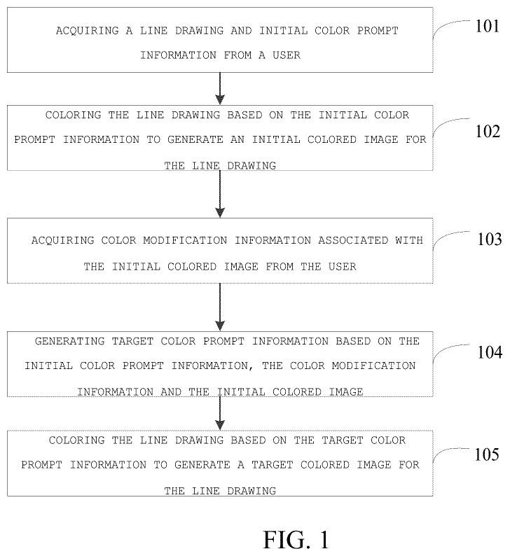

FIG. 1 is a schematic flow diagram of an image processing method in an embodiment of the present disclosure which may be performed by an image processing apparatus, wherein the apparatus may be implemented in software and/or hardware, and may generally be integrated in an electronic device. As shown in FIG. 1, the method comprises:

Step 101: acquiring a line drawing and initial color prompt information from a user.

Wherein, the line drawing can be understood as a line graph that contains only contour information, and the line drawing does not contain color filling.

Moreover, the initial color prompt information is used to indicate the coloring for the line drawing, and the initial color prompt information is different in different application scenarios, and examples thereof are as follows:

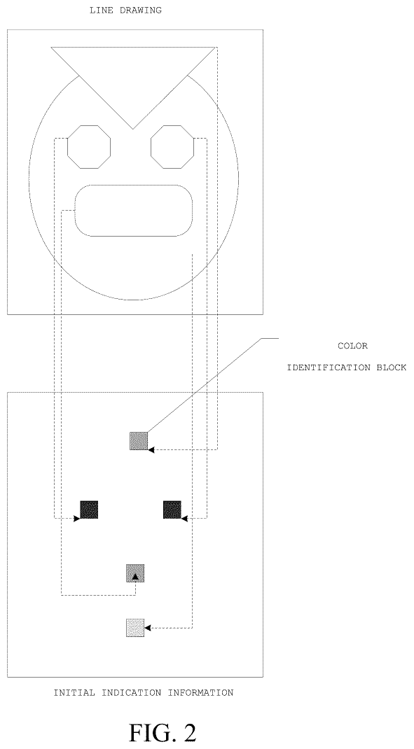

In an embodiment of the present disclosure, the initial color prompt information indicates one or more initial regions in the line drawing and respective initial colors to color the one or more regions specified by the user. Wherein, as shown in FIG. 2, the initial indication information in the present embodiment is in image form, the size of the image is the same as that of the line drawing, and a plurality of color identification blocks are distributed in the image (different colors are identified by different gray scale values in the figure). In a practical application, a semantic segmentation can be performed on the line drawing, and the initial line drawing can be divided into different regions based on the semantic identification result, and a color identification block corresponding to each region can be identified in the image corresponding to the initial indication information, and the color of the corresponding color identification block can be used as an initial color for coloring the region.

In another embodiment of the present disclosure, the name of each part in the line drawing may be obtained according to a semantic identification, a part name list containing all the parts may be displayed, the initial color prompt information input by the user according to the part name list may be acquired. Wherein, the initial color prompt information may be in text form, or may be selected color blocks, etc. For example, the names of the displayed parts are “hair”, “cheeks”, “eyes”, and “mouth”, etc. The user determines initial colors of the parts such as “hair”, “cheeks”, “eyes”, and “mouth”, etc., by selecting a color block, or inputting text, etc.

In another embodiment of the present disclosure, it is not necessary for the user to understand the name of each color, etc., a color reference map may be directly selected, and a reference color for each part may be identified by performing a semantical identification on the color reference map, and a semantical match may be performed between the color reference map and the line drawing, and the reference color of the color reference map for which the semantical match is successful may be used as an initial color of the corresponding part in the line drawing.

Step 102: coloring the line drawing based on the initial color prompt information to generate an initial colored image for the line drawing.

It is easy to understand that the initial color prompt information reflects the user's personalized requirements for initial coloring, at this time, the line drawing is colored based on the initial color prompt information to generate an initial colored image for the line drawing. Wherein the initial colored image is color-filled according to the initial color prompt information.

Wherein, in different application scenarios, the ways in which the line drawing is colored based on the initial color prompt information to generate an initial colored image for the line drawing are different, and are illustrated below:

In an embodiment of the present disclosure, when the initial color prompt information indicates one or more initial regions in the line drawing and respective initial colors to color the one or more regions specified by the user, the one or more initial regions and the respective initial colors and the line drawing are input into a first model which can be understood as a model for coloring which is trained in advance, and then an initial colored image for the line drawing is acquired, to acquire the initial colored image for the line drawing, wherein colors of the one or more initial regions in the initial colored image are consistent with the initial colors.

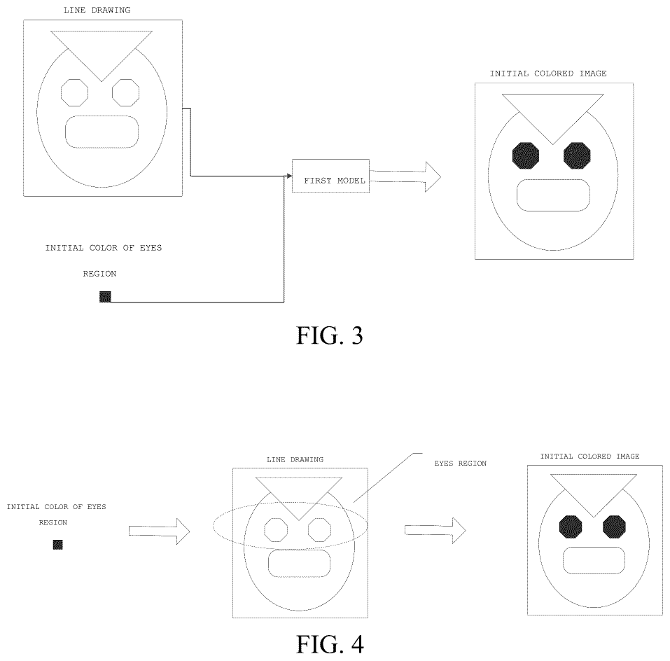

By way of example, as shown in FIG. 3 (where only a change in the color of the indicated region is shown), if the initial color prompt information indicates an initial color of a “eyes” region in the line drawing specified by the user, the initial color of the “eyes” region and the line drawing are input into the first model, and the “eyes” region in the obtained initial colored image is consistent with the initial color.

In another embodiment of the present disclosure, when the initial color prompt information contains an initial color corresponding to each region, a pixel region in which each region is located is identified based on a semantic identification segmentation algorithm, and color values of pixel points in the corresponding pixel regions are altered according to the corresponding initial colors, to obtain the initial colored image.

By way of example, as shown in FIG. 4, if the initial color prompt information indicates an initial color of a “eyes” region in the line drawing specified by the user, the “eyes” region in the line drawing is identified, and the colors of pixel points in the “eyes” region are modified to the corresponding initial color, to obtain the initial colored image, wherein the color of the “eyes” region in the initial colored image is the corresponding initial color.

Wherein, image regions that are not included in the initial color prompt information can be skipped or can be automatically color-filled by a model obtained by pre-learning.

Step 103: acquiring color modification information associated with the initial colored image from the user.

In an actual implementation process, it is possible that the user is not satisfied with the initial colored image, and in the present embodiment, in order to better meet the user's personalized requirements, the color of the initial colored image may be modified for the user's requirements, to meet the user's requirements for local refined modifications, thereby further enhancing the flexibility of the coloring.

In the present embodiment, the color modification information associated with the initial colored image is acquired from the user. Wherein, the associated color modification information may correspond to specific one or more regions in the initial colored image, etc.

Step 104: generating target color prompt information based on the initial color prompt information, the color modification information and the initial colored image.

In an embodiment of the present disclosure, after the initial color prompt information is acquired, the target color prompt information is generated according to the initial color prompt information, the color modification information, and the initial colored image, the target color prompt information reflects the region and color modified by the user in the current scenario. The target color prompt information indicates one or more target regions in the line drawing and respective target colors to color the one or more regions specified by the user.

Wherein, generating the target color prompt information based on the initial color prompt information, the color modification information, and the initial colored image will be illustrated in subsequent embodiments and will not be described in detail here.

Step 105: coloring the line drawing based on the target color prompt information to generate a target colored image for the line drawing.

In the present embodiment, the line drawing is colored based on the target color prompt information, to generate a target colored image for the line drawing, wherein colors of the target regions specified by the user in the target colored image are consistent with respective target colors for coloring the one or more regions contained in the target color prompt information. Wherein, the display form of the target color prompt information may also be the above-mentioned image form, text form, etc. corresponding to the initial color prompt information.

Wherein, for image regions that are not included in the target color prompt information, the filled colors existing in the initial colored image are maintained.

Likewise, in the present embodiment, the one or more target regions and the respective target colors and the line drawing may also be input into the first model, to acquire the target colored image for the line drawing, wherein colors of the one or more target regions in the target colored image are consistent with the target colors.

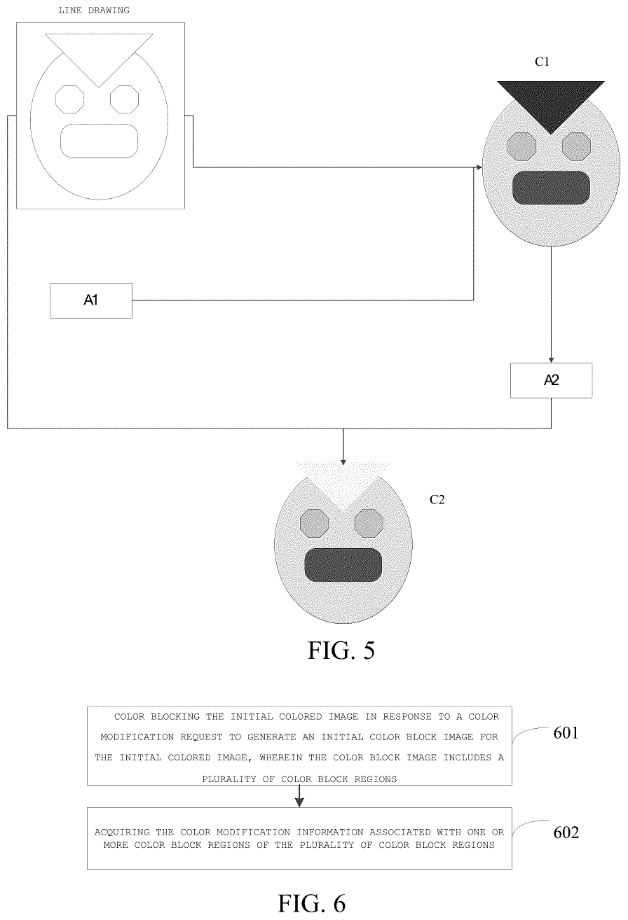

Therefore, the image processing method in the embodiment of the present disclosure is divided into two phases. For example, in the first phase, referring to FIG. 5, in the present embodiment, upon acquiring the line drawing and the initial color prompt information A1 from the user, an initial colored image C1 is obtained by coloring the line drawing according to A1, the C1 is colored entirely, thereby improving the efficiency of coloring.

If the user is not satisfied with the coloring effect for the C1, the second stage is entered, in which color modification information associated with the initial colored image is acquired from the user, wherein the color modification information is local modification information, and if the modification is for the color of the “hair” part, target color prompt information A2 is generated based on the initial color prompt information, the color modification information, and the initial colored image, wherein the target color prompt information is used to indicate a target color for modifying the “hair” part, and the line drawing is colored based on the target color prompt information A2, to generate a target colored image C2 for the line drawing, wherein the color of the “hair” part is locally modified, thereby satisfying the user's requirements for a refined local color.

In summary, in the image processing method in the embodiment of the present disclosure, in conjunction with a line drawing and initial color information provided by the user, firstly a preliminary coloring is performed on the line drawing to obtain an initial colored image, and then associated color modification information is acquired, and target color prompt information is generated according to the color modification information and the initial color prompt information, and then the line drawing is colored based on the target color prompt information, to generate a target colored image for the line drawing. Thereby, an automatic coloring processing is performed on the line drawing according to the color prompt information provided by the user, and if the user modifies the coloring effect, a re-coloring processing can be further performed on the line drawing according to the user's modification, which meets the user's personalized requirements for coloring, and realizes an improvement in the coloring efficiency on the basis of ensuring the coloring effect.

The acquisition of the color modification information associated with the initial colored image is exemplarily illustrated below in conjunction with specific embodiments.

In one embodiment of the present disclosure, as shown in FIG. 6, acquiring the color modification information associated with the initial colored image comprises:

Step 601: color blocking the initial colored image in response to a color modification request to generate an initial color block image for the initial colored image, wherein the color block image includes a plurality of color block regions.

In the present embodiment, in response to a color modification request which may be triggered by the user's voice, or may be triggered by triggering a preset modification control, and the like, and in order to facilitate the user's local refined modifications, in the present embodiment, color blocking is performed on the initial colored image to generate an initial color block image for the initial colored image, wherein the color block image includes a plurality of color block regions.

In some possible embodiments, the initial colored image may be input into a second model which is trained and obtained in advance according to a large amount of sample data, and the second model may obtain a plurality of color block regions and respective region boundaries according to the inputted initial colored image, and then color mean values of pixels in respective color block regions are acquired from the initial colored image based on the region boundaries, and the respective color mean values are used to fill the respective regions of the plurality of color block regions, to acquire the initial color block image, thereby the initial colored image is processed into a color block granularity to facilitate the user's subsequent local modifications for colors based on the color blocks.

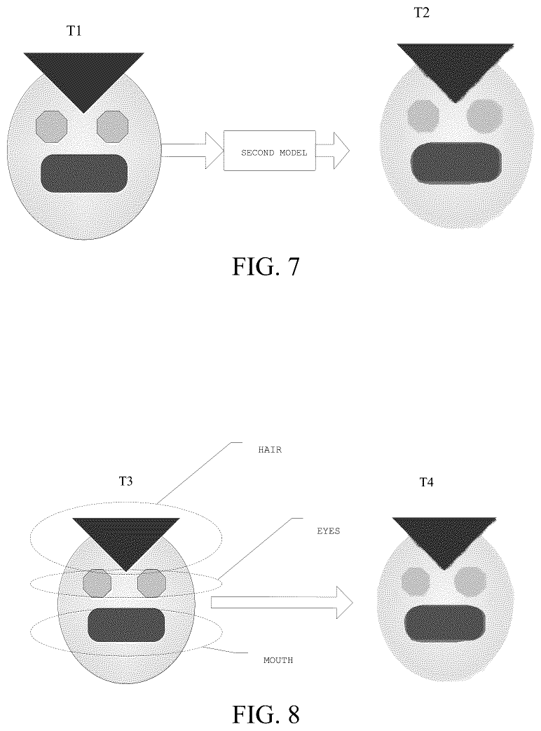

By way of example, as shown in FIG. 7 (where different color block regions are identified by different gray scale values, and corresponding color block regions are identified by regions composed of color blocks that do not contain line contour identifications), when the obtained initial colored image is T1, the T1 is input into a corresponding second model, to obtain a color blocked initial color block image T2, thereby the T1 is processed into a color block dimension to facilitate subsequent local color modifications.

In one embodiment of the present disclosure, a semantic identification may be performed on the initial colored image, to obtain the region in which each part in the initial colored image is located, and values for all pixel points of pixel points in the region in which each part are averaged, and the obtained average value is used as a filling color to fill the region in which the corresponding part is located, to obtain the initial color block image.

By way of example, as shown in FIG. 8 (where different color block regions are identified by different gray scale values, and corresponding color block regions are identified by regions composed of color blocks that do not contain line contour identifications), when the obtained initial colored image is T3, a semantic identification is performed on the T3, to obtain the corresponding parts in the T3 as “eyes”, “mouth”, “hair”, etc., and the region in which each part is located is color blocked to obtain the initial color block image T4, thereby the T3 is processed into a color block dimension to facilitate subsequent local color modifications.

Step 602: acquiring the color modification information associated with one or more color block regions of the plurality of color block regions.

After the initial color block image is obtained, the color modification information associated with one or more color block regions of the plurality of color block regions is acquired, wherein the color modification information corresponds to a color modification for part regions in the initial color block image.

Wherein, the user may realize a determination of the associated color modification information and the like by triggering one or more color block regions of the plurality of color block regions, and inputting modified colors for the triggered color block regions, or employing other colors to paint the corresponding color block regions.

Furthermore, after the color modification information is acquired, the target color prompt information is generated based on the initial color prompt information, the color modification information, and the initial colored image.

Wherein, in different application scenarios, the ways in which the target color prompt information is generated based on the initial color prompt information, the color modification information, and the initial colored image are different, and are illustrated below:

In one embodiment of the present disclosure, a target color block image is acquired from the initial color block image, based on the color modification information associated with one or more color block regions of the plurality of color block regions, wherein the target color block image includes a plurality of color blocks. The target color block image is a color block image after the user modifies colors. The target color prompt information is generated based on the target color block image. For example, if the target color prompt information is an image containing a color block identification, a center region and a boundary region of the target color block image may be determined, and pixel values of the center region and the boundary region may be sampled, to acquire sampled values of a plurality of pixels, and the target color prompt information may be generated according to an average value of the sampled values of the plurality of pixels.

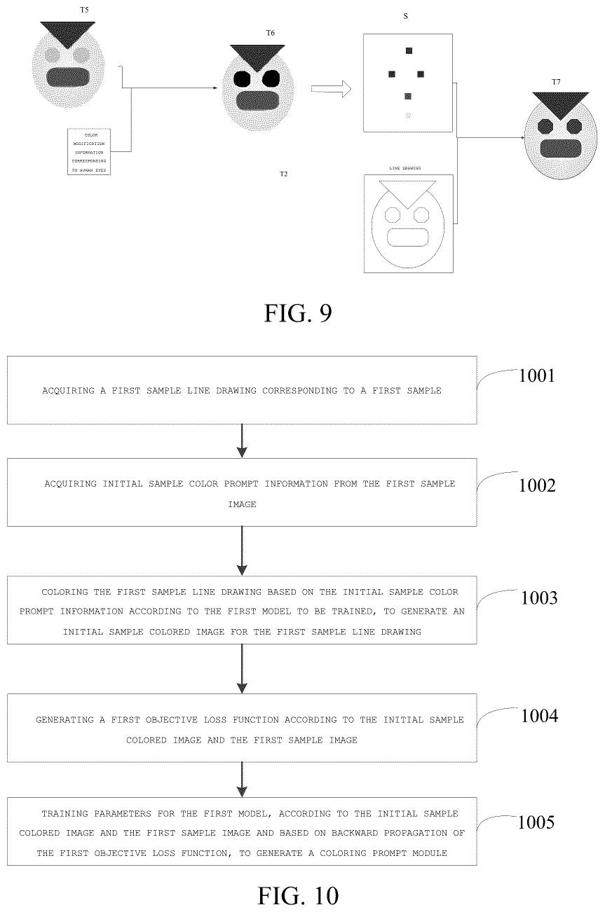

By way of example, as shown in FIG. 9, based on the color modification information for the initial color block image T5, if a color block region corresponds to the human eyes, based on the color corresponding to the color modification information, the color block region corresponding to the human eyes is modified to obtain the target color block image T6, and based on the sampled values of the pixel points of each color block in the target color block image T6, the target color prompt information S is obtained, wherein the S contains a color identification for each color block in the target color block image T6. Further, the target colored image T7 may be obtained by coloring the line drawing according to the S. For example, one or more target regions and corresponding target colors and the line drawing are input into the first model, to obtain the target colored image for the line drawing, wherein colors of the one or more target regions in the target colored image are consistent with the target colors.

In another embodiment of the present disclosure, when the initial color prompt information contains an initial color corresponding to each region, a pixel region in which each color block region in the initial color block image is located is identified based on a semantic identification segmentation algorithm, and color values of pixel points in the corresponding pixel regions are altered based on the color modification information associated with one or more color block regions of the plurality of color block regions, to obtain the target color block image. A color of each color block in the target color block image is identified according to a preset deep learning model, to obtain the target color prompt information.

In summary, in the image processing method in the embodiment of the present disclosure, the color modification information associated with the initial colored image is flexibly acquired according to the scenario requirements, and the line drawing is colored according to the target color prompt information obtained based on the color modification information, to generate the target colored image for the line drawing, thereby greatly improving the flexibility of the coloring processing.

According to an embodiment of the present disclosure, the first model needs to be trained before the first model is employed for the coloring processing, wherein the first model can be regarded as a coloring model.

In one embodiment of the present disclosure, as shown in FIG. 10, if the first model is a coloring prompt model, the coloring prompt model is trained and obtained by the following steps:

Step 1001: acquiring a first sample line drawing corresponding to a first sample image.

In the present embodiment, the first sample image may be a color-filled image, and in the present embodiment, a contour of the first sample image may be identified by a contour identification algorithm or the like, to obtain the first sample line drawing.

Step 1002: acquiring initial sample color prompt information from the first sample image.

In the present embodiment, the initial sample color prompt information is obtained directly from the first sample image, wherein the initial sample color information is used to indicate initial colors of individual sample regions in the first sample image.

Step 1003: coloring the first sample line drawing based on the initial sample color prompt information according to the first model to be trained, to generate an initial sample colored image for the first sample line drawing.

In the present embodiment, the first model to be trained is built in advance, and the first sample line drawing is colored based on the initial sample color prompt information according to the first model to be trained, to generate the initial sample colored image for the first sample line drawing, wherein the initial sample colored image contains the filling color.

Step 1004: generating a first objective loss function according to the initial sample colored image and the first sample image.

It should be understood that the initial sample colored image theoretically should have the same coloring effect as that of the first sample image. Therefore, in order to judge whether the model parameters for the first model to be trained have been trained or not, the first objective loss function is generated according to the initial sample colored image and the first sample image.

Wherein, the algorithms for calculating the first objective loss function are different in different application scenarios, for example, one or more of the following algorithms may be used to calculate the first objective loss function:

In some possible embodiments, an average absolute error in pixel color between each pixel in the initial sample colored image and each pixel in the first sample image is calculated, to acquire a reconstruction loss function. For example, an average value of the average absolute errors for all pixels can be used as the reconstruction loss function, etc.

In some possible embodiments, an mean square error in pixel color value between each pixel in the initial sample colored image and each pixel in the first sample color image is calculated, to acquire a style loss function. For example, an average mean square error for all pixels can be used as the style loss function, etc.

In some possible embodiments, the initial sample colored image and the first sample color image are processed according to a preset discriminator model, to acquire an adversarial loss function, wherein the discriminator model may be a discriminator module in a Generative Adversarial Network (GAN) or the like.

Step 1005: training parameters for the first model, according to the initial sample colored image and the first sample image and based on backward propagation of the first objective loss function, wherein the parameters may be used to generate a coloring prompt model as the first model.

In the present embodiment, the parameters for the first model are trained, according to the initial sample colored image and the first sample image and based on backward propagation of the first objective loss function, in order to generate the coloring prompt model, and when a loss value of the first objective loss function obtained by the first model is less than a preset loss threshold, the training of the model parameters is completed.

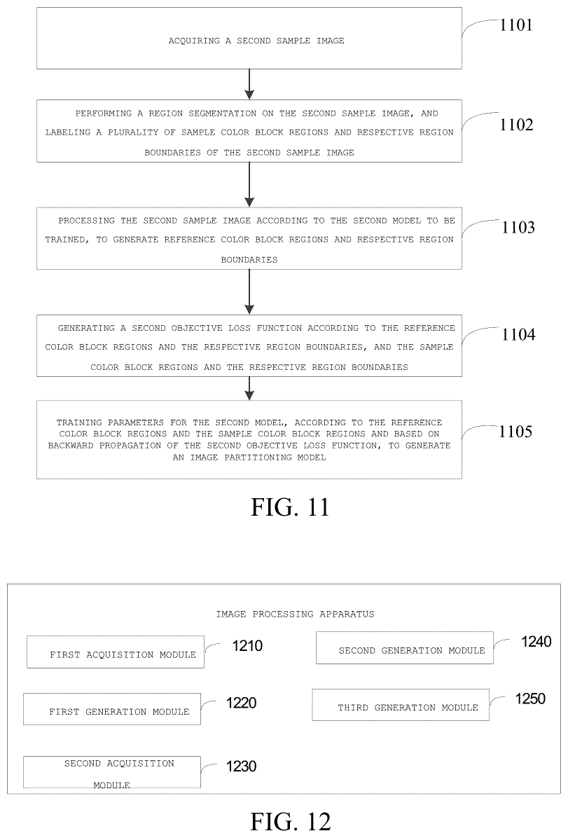

Similarly, the second model needs to be trained before the second model is employed for the color blocking processing. In one embodiment of the present disclosure, the second model is an image partitioning model, and as shown in FIG. 11, the image partitioning model is trained and obtained by the following steps:

Step 1101: acquiring a second sample image.

Wherein, the second sample image may be a color-filled colorful image and the like.

Step 1102: performing a region segmentation on the second sample image, and labeling a plurality of sample color block regions and respective region boundaries of the second sample image.

In the present embodiment, a region segmentation is performed on the second sample image, and the plurality of sample color block regions and the respective region boundaries of the second sample image are labeled, wherein a region segmentation may be performed on the second sample image based on a region segmentation model which is trained in advance, or a semantic analysis may be performed on the second sample image, and then according to the semantic identification result, regions belonging to a same part can be divided into a sample color block region, etc.

Step 1103: processing the second sample image according to the second model to be trained, to generate reference color block regions and respective region boundaries.

In the present embodiment, the second model for color block segmentation is built in advance, and the second sample image is processed according to the second model to be trained, to generate the reference color block regions and the respective region boundaries.

Step 1104: generating a second objective loss function according to the reference color block regions and the respective region boundaries, and the sample color block regions and the respective region boundaries.

It is easy to understand that the obtained reference color block regions theoretically should be consistent with the sample color block regions and the corresponding region boundaries, because the reference color block regions are also from the second sample image. In order to judge whether the model parameters for the second model have been trained or not, in the present embodiment, the second objective loss function is generated according to the reference color block regions and the respective region boundaries, and the sample color block regions and the respective region boundaries.

Wherein, the algorithms for calculating the second objective loss function are different in different application scenarios, for example, one or more of the following algorithms may be used to calculate the second objective loss function:

In some possible embodiments, an average absolute error in pixel color between each pixel in the reference color block region and each pixel in the corresponding sample color block region is calculated, to acquire a reconstruction loss function, and an average absolute error between position information of each pixel point in a corresponding region boundary of the reference color block region, and position information of each pixel point in a corresponding region boundary of the sample color block region is calculated, to acquire a second reconstruction loss function, and a reconstruction loss function between the respective color block regions is acquired based on the first reconstruction loss function and the second reconstruction loss function, for example, the reconstruction loss function between the respective color block regions is acquired based on an average value of the first reconstruction loss function and the reconstruction loss function.

In some possible embodiments, a mean square error in pixel color between each pixel in the reference color block region and each pixel in the corresponding sample color block region is calculated, to acquire a first style loss function, and a mean square error between position information of each pixel point in a corresponding region boundary of the reference color block region, and position information of each pixel point in a corresponding region boundary of the sample color block region is calculated, to acquire a second style loss function, and a style loss function between the respective color block regions is acquired based on the first style loss function and the second style loss function, for example, the style loss function between the respective color block regions is acquired based on an average value of the first style loss function and the second style loss function.

In some possible embodiments, the reference color block regions, the sample color block regions and the respective region boundaries are processed according to a preset discriminator model, to acquire an adversarial loss function, wherein the discriminator model may be a discriminator module in a generative adversarial network or the like.

Step 1105: training parameters for the second model, according to the reference color block regions and the sample color block regions and based on backward propagation of the second objective loss function, wherein the parameters may be used to generate an image partitioning model as the second model.

In the present embodiment, the parameters for the second model are trained according to the reference color block regions and the sample color block regions and based on backward propagation of the second objective loss function, to generate the image partitioning model, and when a loss value of the second objective loss function obtained by the second model is less than a preset loss threshold, the training of the model parameters is completed. The preset loss threshold may be set in a variety of appropriate manners, such as being inferred from historical data, or being set from experience, etc., which will not be described in detail here.

It should be noted that the training processes for the first model and the second model may be performed in various appropriate manners, particularly, in an iterative manner or in a cyclic manner.

According to an embodiment of the present disclosure, the iterations/cycles of the model training may be performed in any appropriate manner. In one embodiment, the processing result of the model may be analyzed during the training process in each iteration/cycle, and in a case where the processing result of the model satisfy a specific condition, the training process may be terminated to obtain a target object flow model. As an example, the training process in each iteration or cycle may be performed as described above, and after the training process in each iteration/cycle is performed, it may be judged whether the objective loss function is less than a preset threshold, and if the objective loss function is less than the preset threshold, the iteration or cycle is stopped and the model training is completed, and conversely, if the objective loss function is not less than the preset threshold, the iteration or cycle continues. In another embodiment, the training process may be terminated after a specific number of cycles to obtain the target object flow model. In still another embodiment, the cycle/iteration process may be stopped if the change in the processing result of the model during a specific number of consecutive cycles/iterations is not significant, for example, remains within a threshold range, such as there being no significant change in the loss value of the loss function. The number of training processes may also be set in a manner appropriate in the art, which will not be described in detail here.

In summary, in the image processing method in the embodiment of the present disclosure, the first model and the second model are trained based on a model training manner, so as to perform the coloring processing according to the first model, and perform image partitioning processing according to the second model, without manual participation, reducing the cost of coloring, and improving the efficiency of coloring.

It should be noted that the model training processes/the model training phases described previously, especially the training processes for the first model and the second model, are optional for the solution in the present disclosure. Particularly, such model training processes/model training phases may be included in the image processing method of the present disclosure, or may be not in the image processing method of the present disclosure and may acquired and applied by the image processing method of the present disclosure. It should be noted that the image processing method of the present disclosure is complete, and capable of achieving beneficial technical results, even if it does not include the model training processes/the model training phases.

According to an embodiment of the present disclosure, the present disclosure further proposes an image processing apparatus. FIG. 12 is a schematic structural diagram of an image processing apparatus in an embodiment of the present disclosure, wherein the apparatus may be implemented in software and/or hardware, and may generally be integrated in an electronic device. As shown in FIG. 12, the apparatus comprises: a first acquisition module 1210, a first generation module 1220, a second acquisition module 1230, a second generation module 1240, and a third generation module 1250, wherein
the first acquisition module 1210 is configured to acquire a line drawing and initial color prompt information from a user;
the first generation module 1220 is configured to generate an initial colored image for the line drawing by coloring the line drawing based on the initial color prompt information;
the second acquisition module 1230 is configured to acquire color modification information associated with the initial colored image from the user;
the second generation module 1240 is configured to generate target color prompt information based on the initial color prompt information, the color modification information and the initial colored image; and
the third generation module 1250 is configured to generate a target colored image for the line drawing by coloring the line drawing based on the target color prompt information.

The image processing apparatus provided by the embodiment of the present disclosure may execute the image processing method provided by any embodiment of the present disclosure, and has functional modules and beneficial effects corresponding to the execution of the method.

It should be noted that the above various modules are only logical modules divided according to the realized specific functions, and are not used to limit the specific manner for implementation, for example, they may be implemented in software, hardware or a combination of software and hardware. In actual implementation, the above various modules may be implemented as separate physical entities, or may either be implemented by a single entity (e.g., a processor (CPU or DSP, etc.), an integrated circuit, etc.). Furthermore, the above various modules are shown with dotted lines in the accompanying drawings to indicate that these modules may not be physically present, and the operations/functions realized by them may be implemented by the apparatus or the processing circuit itself.

Furthermore, although not shown, the apparatus may also include a memory which may store various information generated by the apparatus or the various modules included in the apparatus in operation, programs and data for operation, data to be transmitted by a communication unit, and the like. The memory may be volatile memory and/or non-volatile memory. For example, the memory may include, but is not limited to, random storage memory (RAM), dynamic random storage memory (DRAM), static random access memory (SRAM), read-only memory (ROM), and flash memory. Of course, the memory may also be located outside the apparatus.

In summary, the image processing apparatus in an embodiment of the present disclosure, in conjunction with a line drawing and initial color information provided by the user, firstly performs a preliminary coloring on the line drawing to obtain an initial colored image, then acquires associated color modification information, and generates target color prompt information according to the color modification information and the initial color prompt information, and then colors the line drawing based on the target color prompt information to generate a target colored image for the line drawing. Thereby, an automatic coloring processing is performed on the line drawing according to the color prompt information provided by the user, and if the user modifies the coloring effect, a re-coloring processing can be further performed on the line drawing according to the user's modification, which meets the user's personalized requirements for coloring, and realizes an improvement in the coloring efficiency on the basis of ensuring the coloring effect.

According to an embodiment of the present disclosure, the present disclosure further provides a computer program product comprising a computer program/instruction which, when executed by a processor, implements the image processing method according to the embodiment of the present disclosure.

According to an embodiment of the present disclosure, it further provides a data processing device comprising: a memory, and a processor, wherein the memory stores a computer program which, when executed by the processor, may implement the image processing method according to the embodiment of the present disclosure.

According to an embodiment of the present disclosure, it further provides a computer program comprising program codes which, when executed by a processor, implement the image processing method according to the embodiment of the present disclosure.

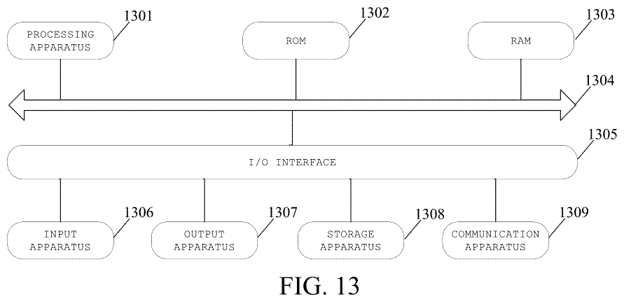

FIG. 13 is a schematic structural diagram of an electronic device in an embodiment of the present disclosure.

Hereinafter specifically referring to FIG. 13, FIG. 13 shows a schematic structural diagram suitable for implementing an electronic device 1300 in an embodiment of the present disclosure. The electronic device 1300 in the embodiment of the present disclosure may include but not limited to a mobile terminal such as a mobile phone, a notebook, a digital broadcast receiver, a PDA (Personal Digital Assistant), a PAD (tablet), a PMP (Portable Multimedia Player), a vehicle-mounted terminal (such as a car navigation terminal), and so on, and a fixed terminal such as a digital TV, a desktop computer, and so on. The electronic device shown in FIG. 13 is only an example, and should not bring any limitation to the functions and scope of usages of the embodiments of the present disclosure.

As shown in FIG. 13, the electronic device 1300 may include a processing apparatus (for example a central processor, a graphics processor, etc.) 1301, which can execute various appropriate actions and processes according to a program stored in a read-only memory (ROM) 1302 or a program loaded from a storage apparatus 1308 into a random-access memory (RAM) 1303. In the RAM 1303, various programs and data required for the operation of the electronic device 1300 are also stored. The processing apparatus 1301, ROM 1302, and RAM 1303 are connected to each other through a bus 1304. An input/output (I/O) interface 1305 is also connected to the bus 1304.

Generally, the following apparatuses can be connected to the I/O interface 1305: an input apparatus 1306 including for example, a touch screen, a touch pad, a keyboard, a mouse, a camera, a microphone, an accelerometer, a gyroscope, etc.; an output apparatus 1307 including for example, a liquid crystal display (LCD), a speaker, a vibrator, etc.; a storage apparatus 1308 including for example, a magnetic tape, a hard disk, etc.; and a communication apparatus 1309. The communication apparatus 1309 may allow the electronic device 1300 to perform wireless or wired communication with other devices to exchange data. Although FIG. 13 shows an electronic device 1300 having various apparatuses, it should be understood that it is not required to implement or have all of the shown apparatuses. It can alternatively be implemented or provided with more or fewer apparatuses.

In particular, according to an embodiment of the present disclosure, the processes described above with reference to the flowcharts can be implemented as computer software programs. For example, an embodiment of the present disclosure includes a computer program product, which includes a computer program carried on a non-transitory computer readable medium, and the computer program contains program code for performing the method shown in the flowchart. In such an embodiment, the computer program may be downloaded and installed from the network through the communication apparatus 1309, or installed from the storage apparatus 1308, or installed from the ROM 1302. When the computer program is executed by the processing apparatus 1301, the above functions defined in the image processing method of the embodiment of the present disclosure are executed.

It should be noted that, the above computer-readable medium in the present disclosure may be a computer-readable signal medium or a computer-readable storage medium, or any combination of thereof. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program, and the program may be used by or in combination with an instruction execution system, apparatus, or device. In the present disclosure, a computer-readable signal medium may include a data signal propagated in a baseband or as a part of a carrier wave, in which a computer-readable program code is carried. This propagated data signal can take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program for use by or in combination with the instruction execution system, apparatus, or device. The program code contained on the computer-readable medium can be transmitted by any suitable medium, including but not limited to: wire, optical cable, RF (Radio Frequency), etc., or any suitable combination thereof.

In some embodiments, the client and server can communicate with any currently known or future developed network protocol such as HTTP (HyperText Transfer Protocol), and can interconnect with digital data communication (for example, communication network) in any form or medium. Examples of communication networks include local area networks (“LAN”), wide area networks (“WAN”), international network (for example, the Internet), and end-to-end networks (for example, ad hoc end-to-end networks), as well as any currently known or future developed networks.

The above computer-readable medium may be included in the above electronic device; or it may exist alone without being assembled into the electronic device.

The above computer-readable medium carries one or more programs, which, when executed by the electronic device, cause the electronic device to: in conjunction with a line drawing and initial color information provided by the user, firstly perform a preliminary coloring on the line drawing to obtain an initial colored image, then acquire associated color modification information, and generate target color prompt information according to the color modification information and the initial color prompt information, and then color the line drawing based on the target color prompt information to generate a target colored image for the line drawing. Thereby, an automatic coloring processing is performed on the line drawing according to the color prompt information provided by the user, and if the user modifies the coloring effect, a re-coloring processing can be further performed on the line drawing according to the user's modification, which meets the user's personalized requirements for coloring, and realizes an improvement in the coloring efficiency on the basis of ensuring the coloring effect.

The computer program code for performing the operations of the present disclosure can be written in one or more programming languages or a combination thereof. The above programming languages include but are not limited to object-oriented programming languages such as Java, Smalltalk, C++, and include conventional procedural programming languages such as “C” language or similar programming languages. The program code can be executed entirely on a user's computer, partly executed on a user's computer, executed as an independent software package, partly executed on a user's computer and partly executed on a remote computer, or entirely executed on a remote computer or server. In the case of involving a remote computer, the remote computer can be connected to a user's computer through any kind of network, including a local area network (LAN) or a wide area network (WAN), or it can be connected to an external computer (for example, connected by using Internet provided by an Internet service provider).

The flowcharts and block diagrams in the accompanying drawings illustrate possible architecture, function, and operation implementations of a system, method, and computer program product according to various embodiments of the present disclosure. In this regard, each block in a flowchart or block diagram may represent a module, program segment, or part of code, which contains one or more executable instructions for realizing specified logic functions. It should also be noted that, in some alternative implementations, functions marked in a block may also occur in a different order than the order marked in the drawings. For example, two blocks shown in succession can actually be executed substantially in parallel, and they can sometimes be executed in the reverse order, depending on functions involved. It should also be noted that, each block in a block diagram and/or flowchart, and the combination of blocks in a block diagram and/or flowchart, can be implemented by a dedicated hardware-based system that performs the specified functions or operations, or it can be implemented by a combination of dedicated hardware and computer instructions.

The units involved in describing the embodiments of the present disclosure may be implemented in software or hardware. Wherein, the names of the units do not constitute limitations on the units themselves under certain circumstances.

The functions described herein above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logical device (CPLD) and so on.

In the context of the present disclosure, a machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage media may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, the present disclosure provides an image processing method comprising: acquiring a line drawing and initial color prompt information from a user;
coloring the line drawing based on the initial color prompt information to generate an initial colored image for the line drawing;
acquiring color modification information associated with the initial colored image from the user;
generating target color prompt information based on the initial color prompt information, the color modification information and the initial colored image; and
coloring the line drawing based on the target color prompt information to generate a target colored image for the line drawing.

According to one or more embodiments of the present disclosure, in the image processing method provided by the present disclosure, the initial color prompt information indicates one or more initial regions in the line drawing and respective initial colors to color the one or more regions specified by the user.

According to one or more embodiments of the present disclosure, the coloring the line drawing based on the initial color prompt information to generate the initial colored image for the line drawing comprises:
inputting the one or more initial regions and the respective initial colors and the line drawing into a first model to acquire the initial colored image for the line drawing, wherein colors of the one or more initial regions in the initial colored image are consistent with the initial colors.

According to one or more embodiments of the present disclosure, the acquiring the color modification information associated with the initial colored image comprises:
color blocking the initial colored image in response to a color modification request to generate an initial color block image for the initial colored image, wherein the color block image includes a plurality of color block regions;
acquiring the color modification information associated with one or more color block regions of the plurality of color block regions.

According to one or more embodiments of the present disclosure, the color blocking the initial colored image in response to the color modification request to generate the initial color block image for the initial colored image comprises:
inputting the initial colored image into a second model to determine the plurality of color block regions and respective region boundaries of the initial colored image;
acquiring color mean values of pixels within respective color block regions from the initial colored image based on the region boundaries;
filling respective regions of the plurality of color block regions using respective color mean values to acquire the initial color block image.

According to one or more embodiments of the present disclosure, the generating the target color prompt information based on the initial color prompt information, the color modification information and the initial colored image comprises:
acquiring a target color block image from the initial color block image based on the color modification information associated with the one or more color block regions of the plurality of color block regions, wherein the target color block image includes a plurality of color blocks;
generating the target color prompt information based on the target color block image.

According to one or more embodiments of the present disclosure, the target color prompt information indicates one or more target regions in the line drawing and respective target colors to color the one or more regions specified by the user.

According to one or more embodiments of the present disclosure, the coloring the line drawing based on the target color prompt information to generate the target colored image for the line drawing comprises:
inputting the one or more target regions and the respective target colors and the line drawing into the first model to acquire the target colored image for the line drawing, wherein colors of the one or more target regions in the target colored image are consistent with the target colors.

According to one or more embodiments of the present disclosure, the first model is a coloring prompt model which is trained and obtained by the following steps:
acquiring a first sample line drawing corresponding to a first sample image;
acquiring initial sample color prompt information from the first sample image;
coloring the first sample line drawing based on the initial sample color prompt information according to the first model to be trained to generate an initial sample colored image for the first sample line drawing;
generating a first objective loss function according to the initial sample colored image
and the first sample image; and
training parameters for the first model according to the initial sample colored image and the first sample image and based on backward propagation of the first objective loss function to generate the coloring prompt model.

According to one or more embodiments of the present disclosure, the second model is an image partitioning model which is trained and obtained by the following steps:
acquiring a second sample image;
performing a region segmentation on the second sample image, and labeling a plurality of sample color block regions and respective region boundaries of the second sample image;
processing the second sample image according to the second model to be trained to generate reference color block regions and respective region boundaries;
generating a second objective loss function according to the reference color block regions and the respective region boundaries, and the sample color block regions and the respective region boundaries; and
training parameters for the second model according to the reference color block regions and the sample color block regions and based on backward propagation of the second objective loss function to generate the image partitioning model.

According to one or more embodiments of the present disclosure, the present disclosure provides an image processing apparatus comprising: a first acquisition module configured to acquire a line drawing and initial color prompt information from a user;
a first generation module configured to generate an initial colored image for the line drawing by coloring the line drawing based on the initial color prompt information;
a second acquisition module configured to acquire color modification information associated with the initial colored image from the user;
a second generation module configured to generate target color prompt information based on the initial color prompt information, the color modification information and the initial colored image; and
a third generation module configured to generate a target colored image for the line drawing by coloring the line drawing based on the target color prompt information.

According to one or more embodiments of the present disclosure, the initial color prompt information indicates one or more initial regions in the line drawing and respective initial colors to color the one or more regions specified by the user.

According to one or more embodiments of the present disclosure, the first generation module is specifically configured to:
acquire the initial colored image for the line drawing by inputting the one or more initial regions and the respective initial colors and the line drawing into a first model, wherein colors of the one or more initial regions in the initial colored image are consistent with the initial colors.

According to one or more embodiments of the present disclosure, the second acquisition module is specifically configured to:
generate an initial color block image for the initial colored image by color blocking the initial colored image in response to a color modification request, wherein the color block image includes a plurality of color block regions;
acquire the color modification information associated with one or more color block regions of the plurality of color block regions.

According to one or more embodiments of the present disclosure, the second acquisition module is specifically configured to: determine the plurality of color block regions and respective region boundaries of the initial colored image by inputting the initial colored image into a second model;
acquire color mean values of pixels within respective color block regions from the initial colored image based on the region boundaries;
acquire the initial color block image by filling respective regions of the plurality of color block regions using respective color mean values.

According to one or more embodiments of the present disclosure, the second acquisition module is specifically configured to: acquire a target color block image from the initial color block image based on the color modification information associated with the one or more color block regions of the plurality of color block regions, wherein the target color block image includes a plurality of color blocks;
generating the target color prompt information based on the target color block image.

According to one or more embodiments of the present disclosure, the target color prompt information indicates one or more target regions in the line drawing and respective target colors to color the one or more regions specified by the user.

According to one or more embodiments of the present disclosure, the third generation module is specifically configured to:
acquire the target colored image for the line drawing by inputting the one or more target regions and the respective target colors and the line drawing into the first model, wherein colors of the one or more target regions in the target colored image are consistent with the target colors.

According to one or more embodiments of the present disclosure, the first model is a coloring prompt model, the apparatus further comprises: a first training module configured to:
acquire a first sample line drawing corresponding to a first sample image;
acquire initial sample color prompt information from the first sample image;
generate an initial sample colored image for the first sample line drawing by coloring the first sample line drawing based on the initial sample color prompt information according to the first model to be trained;
generate a first objective loss function according to the initial sample colored image and the first sample image; and
generate the coloring prompt model by training parameters for the first model according to the initial sample colored image and the first sample image and based on backward propagation of the first objective loss function.

According to one or more embodiments of the present disclosure, the second model is an image partitioning model, the apparatus further comprises: a second training module configured to:
acquire a second sample image;
perform a region segmentation on the second sample image, and label a plurality of sample color block regions and respective region boundaries of the second sample image;
generate reference color block regions and respective region boundaries by processing the second sample image according to the second model to be trained;
generate a second objective loss function according to the reference color block regions and the respective region boundaries, and the sample color block regions and the respective region boundaries; and
generate the image partitioning model by training parameters for the second model according to the reference color block regions and the sample color block regions and based on backward propagation of the second objective loss function.

According to one or more embodiments of the present disclosure, the present disclosure provides an electronic device comprising:
a processor;
a memory configured to store instructions executable by the processor;
the processor is configured to read the executable instructions from the memory and execute the instructions to implement any of the image processing methods as provided by the present disclosure.

According to one or more embodiments of the present disclosure, the present disclosure provides a computer readable storage medium storing a computer program used to perform any of the image processing methods as provided by the present disclosure.

The above description is only preferred embodiments of the present disclosure and an explanation to the technical principles applied. Those skilled in the art should understand that the scope of disclosure involved in this disclosure is not limited to technical solutions formed by specific combination of above technical features, and should also cover other technical solutions formed by arbitrarily combining above technical features or equivalent features thereof without departing from above disclosed concept. For example, those technical solutions formed by exchanging of above features and technical features disclosed in the present disclosure (but not limited to) having similar functions with each other.

In addition, although various operations are depicted in a specific order, this should not be understood as requiring these operations to be performed in the specific order shown or performed in a sequential order. Under certain circumstances, multitasking and parallel processing may be advantageous. Likewise, although several specific implementation details are included in above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although the subject matter has been described in languages specific to structural features and/or logical actions of the method, it should be understood that the subject matter defined in the appended claims is not necessarily limited to the specific features or actions described above. Rather, the specific features and actions described above are merely exemplary forms for implementing the claims.

1. An image processing method, comprising:
acquiring a line drawing and initial color prompt information from a user;
coloring the line drawing based on the initial color prompt information to generate an initial colored image for the line drawing;
acquiring color modification information associated with the initial colored image from the user;
generating target color prompt information based on the initial color prompt information, the color modification information and the initial colored image; and
coloring the line drawing based on the target color prompt information to generate a target colored image for the line drawing.

2. The method according to claim 1, wherein
the initial color prompt information indicates one or more initial regions in the line drawing and respective initial colors to color the one or more regions specified by the user.

3. The method according to claim 2, wherein the coloring the line drawing based on the initial color prompt information to generate the initial colored image for the line drawing comprises:
inputting the one or more initial regions and the respective initial colors and the line drawing into a first model to acquire the initial colored image for the line drawing, wherein colors of the one or more initial regions in the initial colored image are consistent with the initial colors.

4. The method according to claim 2, wherein the acquiring the color modification information associated with the initial colored image comprises:
color blocking the initial colored image in response to a color modification request to generate an initial color block image for the initial colored image, wherein the color block image includes a plurality of color block regions;
acquiring the color modification information associated with one or more color block regions of the plurality of color block regions.

5. The method according to claim 4, wherein the color blocking the initial colored image in response to the color modification request to generate the initial color block image for the initial colored image comprises:
inputting the initial colored image into a second model to determine the plurality of color block regions and respective region boundaries of the initial colored image;
acquiring color mean values of pixels within respective color block regions from the initial colored image based on the region boundaries;
filling respective regions of the plurality of color block regions using respective color mean values to acquire the initial color block image.

6. The method according to claim 4, wherein the generating the target color prompt information based on the initial color prompt information, the color modification information and the initial colored image comprises:
acquiring a target color block image from the initial color block image based on the color modification information associated with the one or more color block regions of the plurality of color block regions, wherein the target color block image includes a plurality of color blocks;
generating the target color prompt information based on the target color block image.

7. The method according to claim 6, wherein the target color prompt information indicates one or more target regions in the line drawing and respective target colors to color the one or more regions specified by the user.

8. The method according to claim 7, wherein the coloring the line drawing based on the target color prompt information to generate the target colored image for the line drawing comprises:
inputting the one or more target regions and the respective target colors and the line drawing into the first model to acquire the target colored image for the line drawing, wherein colors of the one or more target regions in the target colored image are consistent with the target colors.

9. The method according to claim 3, wherein the first model is a coloring prompt model which is trained and obtained by the following steps:
acquiring a first sample line drawing corresponding to a first sample image;
acquiring initial sample color prompt information from the first sample image;
coloring the first sample line drawing based on the initial sample color prompt information according to the first model to be trained to generate an initial sample colored image for the first sample line drawing;
generating a first objective loss function according to the initial sample colored image and the first sample image; and
training parameters for the first model according to the initial sample colored image and the first sample image and based on backward propagation of the first objective loss function to generate the coloring prompt model.

10. The method according to claim 9, wherein when a loss value of the first objective loss function obtained based on the first model is less than a preset loss threshold, the training of the parameters for the first model is completed.

11. The method according to claim 5, wherein the second model is an image partitioning model which is trained and obtained by the following steps:
acquiring a second sample image;
performing a region segmentation on the second sample image, and labeling a plurality of sample color block regions and respective region boundaries of the second sample image;
processing the second sample image according to the second model to be trained to generate reference color block regions and respective region boundaries;
generating a second objective loss function according to the reference color block regions and the respective region boundaries, and the sample color block regions and the respective region boundaries; and
training parameters for the second model according to the reference color block regions and the sample color block regions and based on backward propagation of the second objective loss function to generate the image partitioning model.

12. The method according to claim 11, wherein when a loss value of the second objective loss function obtained based on the second model is less than a preset loss threshold, the training of the parameters for the second model is completed.

13. (canceled)

14. An electronic device, comprising:
a processor; and
a memory configured to store instructions executable by the processor;
wherein the executable instructions are executed by the processor for implementing an image processing method comprising:
acquiring a line drawing and initial color prompt information from a user;
coloring the line drawing based on the initial color prompt information to generate an initial colored image for the line drawing;
acquiring color modification information associated with the initial colored image from the user;
generating target color prompt information based on the initial color prompt information, the color modification information and the initial colored image; and
coloring the line drawing based on the target color prompt information to generate a target colored image for the line drawing.

15. A non-transitory computer readable storage medium storing a computer program executed by a processor for implementing an image processing method comprising:
acquiring a line drawing and initial color prompt information from a user;
coloring the line drawing based on the initial color prompt information to generate an initial colored image for the line drawing;
acquiring color modification information associated with the initial colored image from the user;
generating target color prompt information based on the initial color prompt information, the color modification information and the initial colored image; and
coloring the line drawing based on the target color prompt information to generate a target colored image for the line drawing.

16-17. (canceled)

18. The electronic device according to claim 14, wherein
the initial color prompt information indicates one or more initial regions in the line drawing and respective initial colors to color the one or more regions specified by the user.

19. The electronic device according to claim 18, wherein the coloring the line drawing based on the initial color prompt information to generate the initial colored image for the line drawing comprises:
inputting the one or more initial regions and the respective initial colors and the line drawing into a first model to acquire the initial colored image for the line drawing, wherein colors of the one or more initial regions in the initial colored image are consistent with the initial colors.

20. The electronic device according to claim 19, wherein the first model is a coloring prompt model which is trained and obtained by the following steps:
acquiring a first sample line drawing corresponding to a first sample image;
acquiring initial sample color prompt information from the first sample image;
coloring the first sample line drawing based on the initial sample color prompt information according to the first model to be trained to generate an initial sample colored image for the first sample line drawing;
generating a first objective loss function according to the initial sample colored image and the first sample image; and
training parameters for the first model according to the initial sample colored image and the first sample image and based on backward propagation of the first objective loss function to generate the coloring prompt model.

21. The non-transitory computer readable storage medium according to claim 15, wherein
the initial color prompt information indicates one or more initial regions in the line drawing and respective initial colors to color the one or more regions specified by the user.

22. The non-transitory computer readable storage medium according to claim 21, wherein the coloring the line drawing based on the initial color prompt information to generate the initial colored image for the line drawing comprises:
inputting the one or more initial regions and the respective initial colors and the line drawing into a first model to acquire the initial colored image for the line drawing, wherein colors of the one or more initial regions in the initial colored image are consistent with the initial colors.

23. The non-transitory computer readable storage medium according to claim 22, wherein the first model is a coloring prompt model which is trained and obtained by the following steps:
acquiring a first sample line drawing corresponding to a first sample image;
acquiring initial sample color prompt information from the first sample image;
coloring the first sample line drawing based on the initial sample color prompt information according to the first model to be trained to generate an initial sample colored image for the first sample line drawing;
generating a first objective loss function according to the initial sample colored image and the first sample image; and
training parameters for the first model according to the initial sample colored image and the first sample image and based on backward propagation of the first objective loss function to generate the coloring prompt model.
